(19) United States
(12) Patent Application Publication
(10) Pub. No.: US 2004/0241392 A1
(43) Pub. Date: Dec. 2, 2004

(54) Polyurethane and rigid substrate composite

(76) Inventor: Vincent Sorrentino, Poinciana, FL (US)

Correspondence Address: LOTT & FRIEDLAND, P.A., P.O. BOX 141098, CORAL GABLES, FL, 33114-1098, US

(21) Appl. No.: 10/452,259

(22) Filed: Jun. 2, 2003

(51) Int. Cl. B32B 1/00

(52) U.S. Cl. 428/151

(57) ABSTRACT

A polyurethane and rigid substrate composite that can be used in the construction of outdoor furniture.

### FIELD OF INVENTION

The present invention relates generally to the field of materials engineering, and more particularly, to a polyurethane and rigid substrate composite that can be used in the construction of outdoor furniture.

### BACKGROUND OF THE INVENTION

New furniture is always in demand by consumers in the United States and abroad. Today's economy has created a particularly hospitable environment for furniture manufacturers. Low interest rates have stimulated new housing starts and sales. New-home sales for August of this year were pegged at 996,000, up 1.9% from July and 14.4% from August of last year. New-home sales have trended up throughout the past year, and August's number was up 16.4% from the 13-month low of 856,000 in September 2001. New housing typically translates to higher sales numbers for the furniture industry. If furniture spending continues at the present pace, it will finish the year at $66.8 billion, up sharply from 2001's $64 billion. http://www.furnituretoday.com/news/news10-14-02d.shtl.

A sub-segment of the consumer furniture industry is outdoor furniture. Outdoor furniture sales continue to rise with the overall trends. Although outdoor furniture can be constructed of various materials, weather resistant materials are obviously more favorable. One such material is polyurethane. Introduced commercially in 1954, urethanes have made an impact on a broad spectrum of U.S. industry. They are extremely versatile plastics in terms of the forms in which they are available: flexible or rigid foams, solid elastomers (or rubbers), coatings, adhesives and sealants. Their versatility also extends to chemical structure in that, although the urethanes are generally considered to be thermosets, there are grades of urethane elastomers that are thermoplastic in nature and are supplied in pellet form for molding, calendering and extrusion. Polyurethane's major and best known form, however, is a foamed or “cellular”*material.

Like all urethanes, the foams are prepared by first reacting two liquid components—polyols and isocyanates—together. In the presence of a blowing agent, this reaction will produce a foamed material having excellent thermal insulating properties, and, in fact, polyurethane foam is widely used in building insulation. The foams can either be soft and flexible or tough, and rigid, with all the possible variations in-between. Flexible foams have outstanding cushioning characteristics, excellent energy-absorbing properties and long life. They are used in furniture, cushioning, carpet underlay, bedding, packaging, textiles and automotive seating and safety padding. Rigid foams offer outstanding insulating values, excellent compressive strength, good dimensional stability and buoyancy. Besides building insulation, they are also found in refrigerators, trucks, boats (for flotation), and in the construction of furniture components.

As coatings, polyurethanes impart excellent protective and decorative effects to wood, metals, rubber, textiles, concrete, paper, leather, other plastics and many other materials. In the form of elastomers, polyurethanes offer superior abrasion resistance and toughness, and are used in applications in which good performance and long service life are important: printing rolls, gaskets and seals, cable insulation, drive and conveyor belts, solid tires and automotive applications. http://www.socplas.org/industry/defs.htm

Previous attempts have been made to provide polyurethane foam structures for possible use with furniture, such as described in U.S. Pat. No. 6,482,875 to Lorenz, et al. (→875 patent); U.S. Pat. No. 6,481,476 to Okamoto (→476 patent); U.S. Pat. No. 5,173,990 to Owen (→990 patent); U.S. Pat. No. 5,037,860 to Parrish, et al. (→860 patent); and U.S. Pat. No. 4,714,574 to Tenhagen (→574 patent); all of which are incorporated herein by reference.

The ′875 patent describes a thermoplastic composite material containing at least 15 percent by weight of one or more organic fibrous material, and at least 15 percent by weight of thermoplastic binder, with binder containing at least two different polyacrylates. The thermoplastic composite material has a flow transition range of 70 degrees C. to 130 degrees C. The invention also relates to a method for producing the thermoplastic composite material and the use of the thermoplastic composite material to coat the surfaces of objects. The ′875 does not provide a wood-like appearance for the thermoplastic composite material, rather, it incorporates natural fibers such as wood in order to make the material more suited for its purpose.

The ′476 patent describes a method of manufacturing an artificially figured veneer or artificially figured board at high productivity with the expression of the grain and figure of natural wood in very similar form observed in natural woods, in addition to normal grain of natural wood. The present invention relates to the method of manufacturing an artificially figured veneer or an artificially figured board, comprising the steps of 1) preparing a set of a multiple sheets of material veneers by rotary cutting a log or repeatedly cutting a wood flitch with their grains sequential, 2) embossing simultaneously said material veneers whose number was determined according to the static bending strength (proportional limit) and specific gravity of the material veneers, with press dies having concave-convex patterns corresponding to a site of figure of a natural wood, to form a concave-convex pattern on the material veneers, 3) laminating the set of embossed material veneers such that their grains become substantially sequential, and pressing it with said press dies, and 4) cutting the laminate in the direction crossing the plane of the lamination to manufacture an artificially figured veneer or an artificially figured board with desired thickness. While the ′476 patent is directed towards providing an artificial material that appears like wood, it is used merely as a veneer and not as a weight bearing member as would be used in furniture, for example.

The ′990 patent describes a furniture, or bed support and caster protector device, consisting of a sleeve or cylindrical body constructed of a generally resilient material having a hollow center and adapted to circumvallate the bed support and the supporting caster thereof, a radially disposed cut in the sleeve extending along at least one radius thereof to provide accessing of the sleeve around the bed support and caster, and also to facilitate its removal therefrom, and the sleeve having a longitudinal dimension being slightly grater in distance than an overall distance between a bed rail, disposed at an upper extremity of the bed support, and a support plane or floor for support of the caster, to effect a slight compression of the sleeve due to its resilient characterization and tending to retain the sleeve in locus between the bed rail and the support plane or floor; the sleeve has a lower section with a larger diameter at the lower section and has an upper section with a smaller diameter to provide more distribution of the slight compression within the upper section than in the lower section. This relates more particularly to a quickly applied cushioning cover for bed supports, and casters, to prevent accidental injury to the feet, ankles and shins of the person coming into accidental contact with the bed. The material of the sleeve is of a sponge material, an elastomeric material, an expanded polyurethane material, a foam material, a resinous material, or an open cell material that is removably available for washing and sanitizing the device. While the ′990 patent provides a product that utilizes polyurethane, it does not appear like wood, and is not used for the same purpose as the present invention.

The ′860 patent describes flexible foam prepared using 1,1,1-trichloroethane as the sole or predominant auxiliary blowing agent. The ′860 patent describes a polyurethane product that uses an ethane based blowing agent, however the primary purpose of the ′860 is to provide 1,1,1-trichloroethane as a blowing agent, not to provide a material that has a natural appearance for use in outdoor furniture.

The ′574 patent describes a flexible polyurethane foam article with regions of different hardness is made by introducing into a mould a foam formulation giving a foam of a given hardness and then introducing a foam formulation giving a foam of different hardness directly onto the first foam formulation at a time corresponding to a volume expansion in the range 100% to 2300%. The ′574 patent describes polyurethane foam for use with seats, however, it provides for foam cushions exhibiting different levels hardness throughout the structure. In addition, there are no provisions for making it appear natural for use with outdoor furniture.

Consequently, there is a need in the art for a polyurethane foam product, made with pethane as a blowing agent, that is adapted to look like a naturally occurring substance, such as wood, and can be used in the construction of outdoor furniture.

There is a further need in the art for there is a need in the art for a polyurethane foam product that is adapted to look like a naturally occurring substance, such as wood, used in conjunction with a rigid substrate and can be used in the construction of outdoor furniture.

### SUMMARY OF THE INVENTION

The present invention solves significant problems in the art by providing a composite product that can be used in the manufacture of outdoor furniture that is weather resistant, inexpensive to make and provides an attractive appearance to the furniture.

A preferred embodiment of the invention provides a composite product for use in manufacturing outdoor furniture, comprising a substrate material and polyurethane foam, whereby the foam fully encapsulates the substrate and provides a wood grain appearance.

In an alternative embodiment, the invention provides an article of furniture manufactured using a composite product comprising a substrate material and polyurethane foam, whereby the foam fully encapsulates the substrate and provides a wood grain appearance.

In a further alternative embodiment, the invention provides a composite product, made with pethane as a blowing agent, for use in manufacturing outdoor furniture, comprising a substrate material, whereby the substrate material is made of steel; and, polyurethane foam, whereby the foam fully encapsulates the substrate and provides a wood grain appearance.

Accordingly, it is an object of the present invention to provide a polyurethane foam product, made with pethane as a blowing agent, that is adapted to look like a naturally occurring substance, such as wood, and can be used in the construction of outdoor furniture.

It is another object of the present invention to provide a polyurethane foam product that is adapted to look like a naturally occurring substance, such as wood, used in conjunction with a rigid substrate and can be used in the construction of outdoor furniture.

These and other objects, features and advantages of the present invention may be better understood and appreciated from the following detailed description of the embodiments thereof, selected for purposes of illustration and shown in the accompanying drawings.

### BRIEF DESCRIPTION OF THE DRAWINGS

FIG. 1 is a perspective, cross-sectional view of a preferred embodiment of the invention.

FIG. 2 is a perspective view of the rigid substrate in a preferred embodiment of the present invention.

FIG. 3 is a top or bottom view of a preferred embodiment of the invention.

FIG. 4 is a side view of a preferred embodiment of the invention.

FIG. 5 is an end view of a preferred embodiment of the invention.

FIG. 6 is an illustration of the invention being used for outdoor furniture.

### DETAILED DESCRIPTION OF THE PREFERRED EMBODIMENT

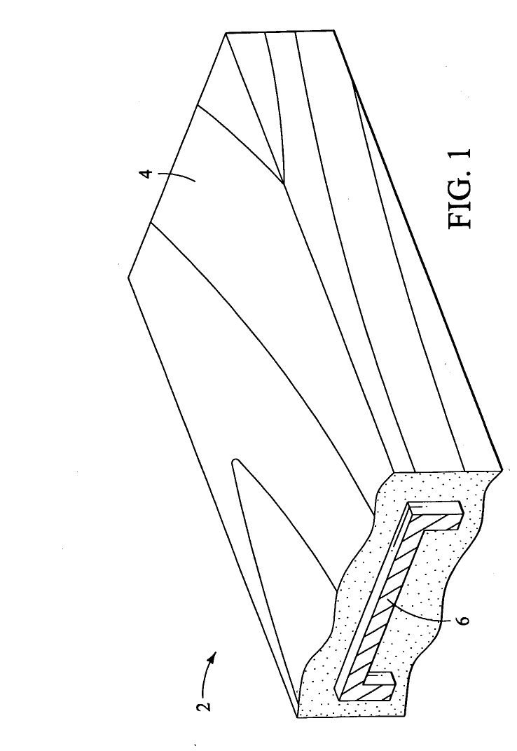

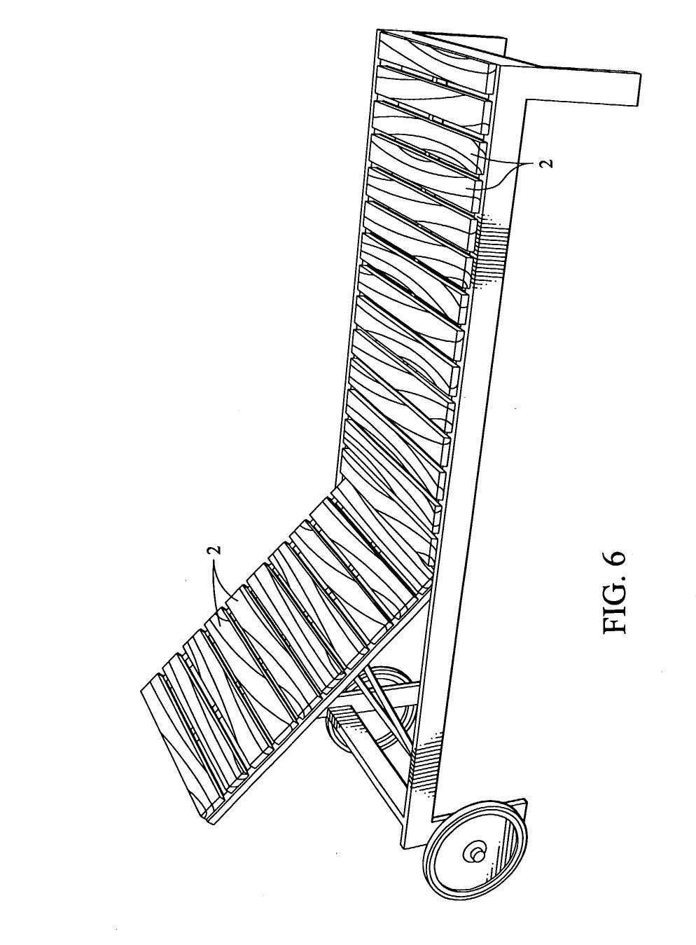

Referring initially to FIG. 1 of the drawings, in which like numerals indicate like elements throughout the several views, in a preferred embodiment a perspective, cross-section of the invention In can be seen. The composite product 2 is comprised of outer polyurethane foam 4 and a substrate 6, such as steel, for supplying extra rigidity to the overall product 2. While steel is discussed herein, the substrate can be any material that provides additional rigidity to the polyurethane foam, for example, wood, metals other than steel, stone or composite materials. The extra rigidity allows the product 2 to be used for weight bearing applications, such as furniture, see FIG. 6. An additional advantage of using the rigid substrate 6 is that it allows for product to be fastened to the frame in virtually any configuration. To provide for maximum life of the product 2, the rigid substrate 6 is completely enclosed in the polyurethane foam 4. Encased in the polyurethane 4, the substrate 6 is protected from the weather. Center supports can be used behind the product 2 if unusually large amounts of force are expected.

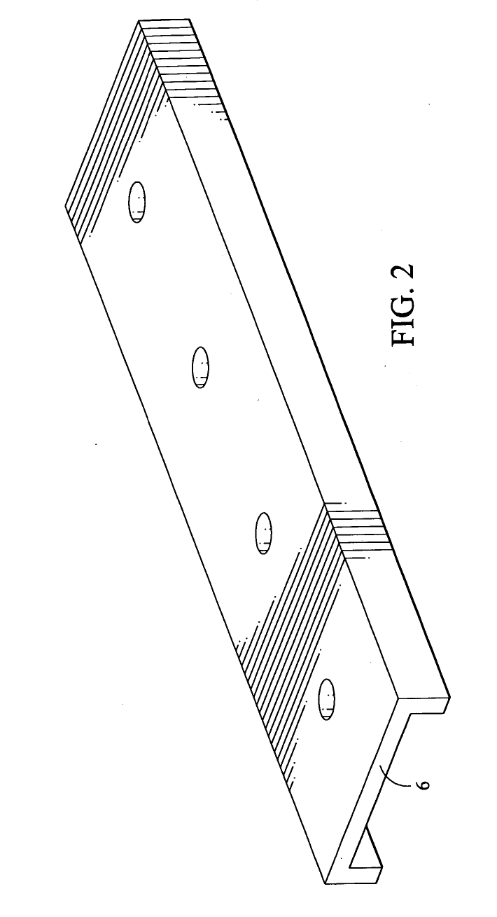

As illustrated in FIG. 2, the substrate 6 is vented in a preferred embodiment of the present invention. The venting allows for the polyurethane foam 4 to become intertwined with the substrate 6 in order to form a more secure bond between the two components during manufacturing. The holes also facilitate polyurethane 4 flow around the substrate 6 during manufacturing. Although not a requirement, this configuration is preferred to a non-vented substrate 6.

During the manufacturing of the product 2, a volatile organic substance such as pethane should be used as the blowing agent. Water is often used in the manufacture of polyurethane foams, however it provides a less weather resistant foam so it should not be used for the purpose of making outdoor furniture. There are two general types of urethane processing machines, high pressure and low pressure. High pressure machines use high pressure impingement mixing, that is, the two streams come together at high pressure in the mix head before the material is dispensed into the mold. A low pressure machine uses a dynamic mix head (spinning mixer) to intimately mix the two components in the mix chamber before the material is dispensed into the mold. In the preferred embodiment of the present invention, the low pressure machine is used to combine the urethane foam material and the pethane blowing agent.

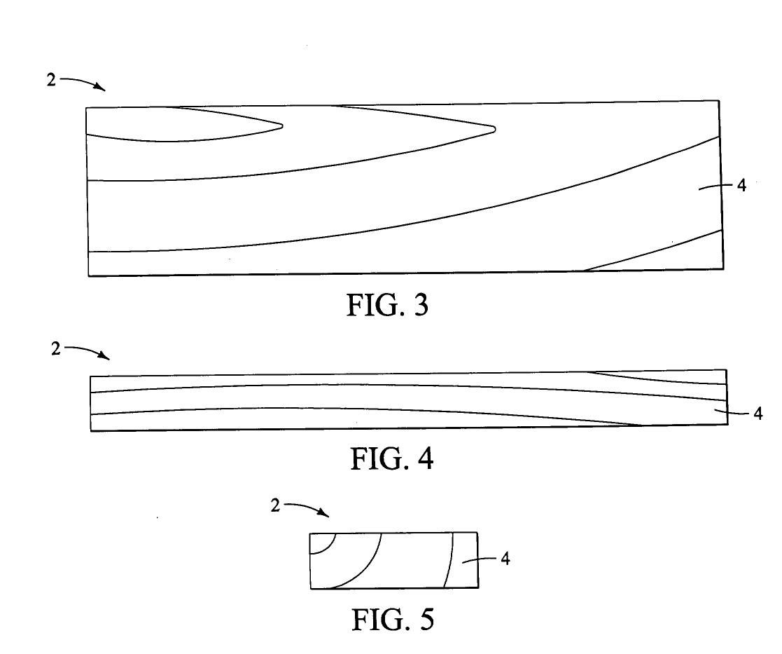

FIGS. 3-5 show varying views of the invention and the natural wood-like appearance. FIG. 3 is a top or bottom view, FIG. 4 illustrates the side, and FIG. 5 is representative of the end view. It is important to note that the wood grain depicted in the Figures is merely representative of the type of wood grain the invention can portray. As with nature, the artificial wood grain can take on almost infinite variation and still appear to be natural wood. The mold used to create the polyurethane foam 4 primarily dictates the grain.

Turning to FIG. 6, an illustration of the invention being used for outdoor furniture is depicted. The article of furniture is a typical lawn chair 10 with an adjustable backrest 12 capable of inclining (to the sitting upright position) or declining (to the laying down position). Slats 16 of the present invention are used for the armrests 14 and the seat material. The product 2 is attached to the furniture frame by an adhesive in the preferred embodiment.

Accordingly, it will be understood that the preferred embodiment of the present invention has been disclosed by way of example and that other modifications and alterations may occur to those skilled in the art without departing from the scope and spirit of the appended claims.

What is claimed is:

1. A composite product for use in manufacturing outdoor furniture, comprising:
a substrate material; and,
a polyurethane foam, whereby said foam fully encapsulates said substrate and provides a wood grain appearance.

2. The product of claim 1, wherein said product is manufactured using pethane as a blowing agent.

3. The product of claim 1, wherein said substrate material is made of steel.

4. An article of furniture manufactured using a composite product comprising a substrate material and polyurethane foam, whereby said foam fully encapsulates said substrate and provides a wood grain appearance.

5. The article of claim 4, wherein said product is manufactured using pethane as a blowing agent.

6. The article of claim 4, wherein said substrate material is made of steel.

7. The article of claim 4, wherein said product can be reinforced with center supports.

8. A composite product, made with pethane as a blowing agent, for use in manufacturing outdoor furniture, comprising:
a substrate material, whereby said substrate material is made of steel; and,
polyurethane foam, whereby said foam fully encapsulates said substrate and provides a wood grain appearance.
